(19) United States
(12) Patent Application Publication
(10) Pub. No.: US 2026/0342506 A1
(43) Pub. Date: Oct. 29, 2026

(54) BACKSCATTERING DATA TRANSMISSIONS ON CONFIGURED RESOURCES

(71) Applicant: QUALCOMM INCORPORATED, San Diego, CA (US)

(72) Inventors: Chao WEI, Beijing (CN); Mingxi YIN, Beijing (CN); Ruiming ZHENG, Beijing (CN); Kangqi LIU, San Diego, CA (US); Hao XU, Beijing (CN)

(21) Appl. No.: 19/114,369

(22) PCT Filed: Dec. 2, 2022
(86) PCT No.: PCT/CN2022/136088

§ 371 Date: Mar. 21, 2025

(51) Int. Cl. H04L 5/00

(52) U.S. Cl. CPC H04L 5/0048

(57) ABSTRACT

Apparatuses and methods for backscattering data transmissions on configured resources are described. An apparatus is configured to receive a configuration for backscatter link resources and resources for at least one reference signal associated with the backscatter link resources, and to receive a reference signal from the at least one reference signal associated with the backscatter link resources. The apparatus is also configured to backscatter an information signal in a backscatter link resource from the configuration in response to receiving the reference signal. Another apparatus is configured to transmit a reference signal associated with a configuration of backscatter link resources, and to transmit a carrier signal to a passive backscatter device. The apparatus is also configured to receive a backscatter signal in an backscatter link resource from the configuration in response to the reference signal and based on the carrier signal.

### TECHNICAL FIELD

The present disclosure relates generally to communication systems, and more particularly, to wireless communications utilizing backscatter.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to receive a configuration for backscatter link resources and periodic resources for at least one reference signal associated with the backscatter link resources. The apparatus is also configured to receive a reference signal from the at least one reference signal associated with the backscatter link resources. The apparatus is further configured to backscatter an information signal in a backscatter link resource from the configuration in response to receiving the reference signal.

In the aspect, the method includes receiving a configuration for backscatter link resources and periodic resources for at least one reference signal associated with the backscatter link resources. The method also includes receiving a reference signal from the at least one reference signal associated with the backscatter link resources. The method further includes backscattering an information signal in a backscatter link resource from the configuration in response to receiving the reference signal.

In another aspect of the disclosure, a method, a computer-readable medium, and an apparatus are provided. The apparatus is configured to transmit a reference signal associated with a configuration of backscatter link resources. The apparatus is also configured to transmit a carrier signal to a passive backscatter device. The apparatus is further configured to receive a backscatter signal in an backscatter link resource from the configuration in response to the reference signal and based on the carrier signal.

In the aspect, the method includes transmitting a reference signal associated with a configuration of backscatter link resources. The method also includes transmitting a carrier signal to a passive backscatter device. The method further includes receiving a backscatter signal in an backscatter link resource from the configuration in response to the reference signal and based on the carrier signal.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example backscatter communications, in accordance with various aspects of the present disclosure.

FIG. 5 is a diagram illustrating an example of passive UE mobility, in accordance with various aspects of the present disclosure.

FIG. 6 is a call flow diagram for wireless communications, in accordance with various aspects of the present disclosure.

FIG. 7 is a diagram illustrating example backscatter transmissions on configured UL resources, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a diagram illustrating an example of a hardware implementation for an example apparatus and/or reader.

FIG. 11 is a diagram illustrating an example of a hardware implementation for an example reader.

FIG. 12 is a diagram illustrating an example of a hardware implementation for an example passive backscatter device.

### DETAILED DESCRIPTION

Various aspects relate generally to backscattering information signals on configured resources that are triggered or activated by reception of an associated reference signal. Some aspects more specifically relate to enabling a configuration of backscatter link signals, similar to a configured grant, that can be activated by transmission of a reference signal from a reader to a passive backscatter device. In some examples, a passive backscatter device may receive a configuration, e.g., from a reader or a network node such as a base station, for backscatter link resources and resources for a reference signal(s) associated with the backscatter link resources. The passive backscatter device may then receive a reference signal from the configured reference signal(s) associated with the backscatter link resources. In such aspects, the passive backscatter device may be configured to backscatter an information signal in a backscatter link resource from the configuration in response to receiving the reference signal. The passive backscatter device may harvest energy from energy packets after the reference signal is received and/or between backscattering information signals in order to have power to backscatter the information signal in the previously configured resources. Thus, passive IoT devices are enabled to actively initiate communications to a reader via supporting backscatter transmissions on configured backscatter link resources (e.g., similar to a configured grant of backscatter link resources activated by the reception of the reference signal), are enabled to better support low latency mobile-originated traffic, and are enabled to reduce DL control overhead from a reader to passive IoT devices.

The use of the reference signal to trigger the passive backscatter device to begin backscattering an information signal using previously configured backscatter link resources reduced latency for backscattered information in comparison to a query-response protocol. For example, the passive backscatter device is enabled to transmit by backscattering a number of times based on one triggering reference signal, whereas in query-response protocols, a single query prompts a single response. Additionally, the use of configured backscatter link resources helps to reduce signaling overhead to allocate resources for backscattering and configure the transmission parameters for backscattering. The use of the reference signal to activate the configured backscatter link resources allows for mobility in passive backscatter devices because each reference signal can be associated with one of multiple readers. Further, flexible resource assignments for backscattering are enabled. For example, a reader may select a reference signal and corresponding resources for backscattering based on a transmission strategy to provide an energy packet to power the passive backscatter device, and the traffic requirements by the passive backscatter device.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

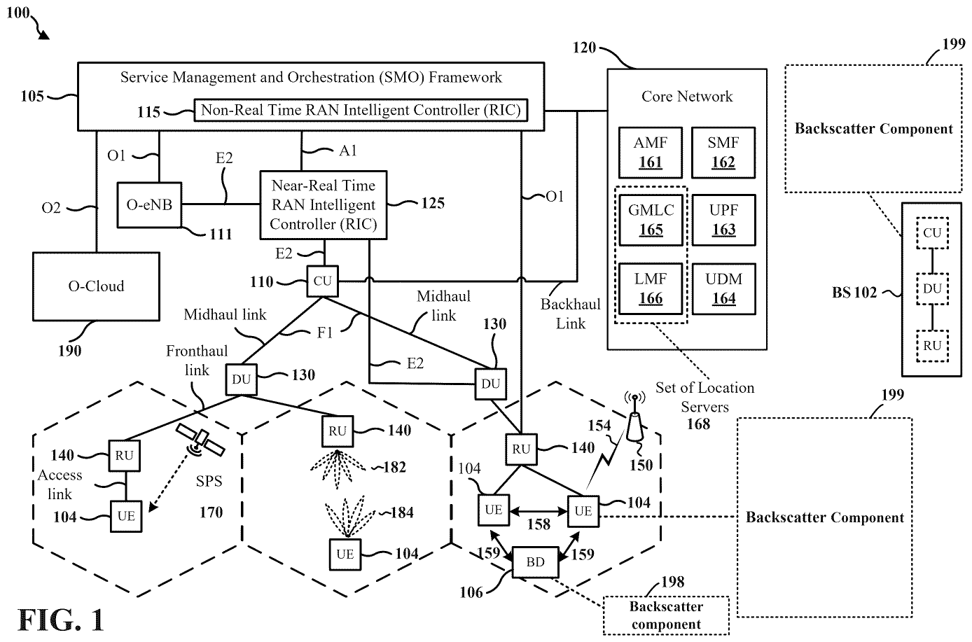

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming.

The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

FIG. 1 illustrates an example of a passive backscatter device 106 having a backscatter link 159 to UEs 104 as examples of a reader. The passive backscatter device 106 may include a backscatter component 198 configured to receive a configuration for backscatter link resources and periodic resources for at least one reference signal associated with the backscatter link resources. The backscatter component 198 is also configured to receive a reference signal from the at least one reference signal associated with the backscatter link resources. The backscatter component 198 is further configured to backscatter an information signal in a backscatter link resource from the configuration in response to receiving the reference signal. In some aspects, a UE 104 or a network node such as a base station 102 or a component of a base station 102, such as a CU 110, DU 130, or RU 140, may include a backscatter component 199 configured to transmit a reference signal associated with a configuration of backscatter link resources. The backscatter component 199 is also configured to transmit a carrier signal to a passive backscatter device. The backscatter component 199 is further configured to receive a backscatter signal in an backscatter link resource from the configuration in response to the reference signal and based on the carrier signal.

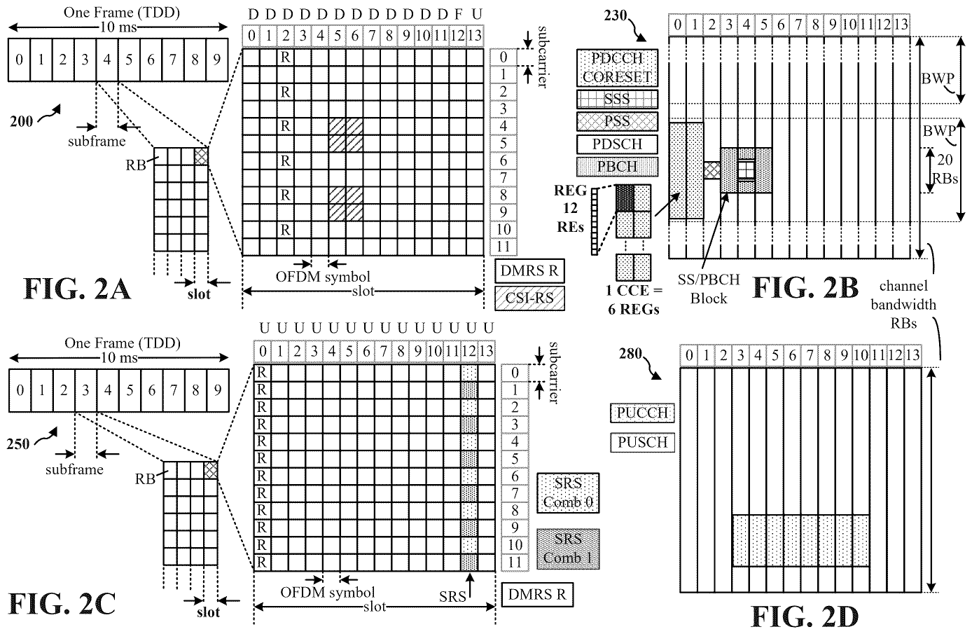

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

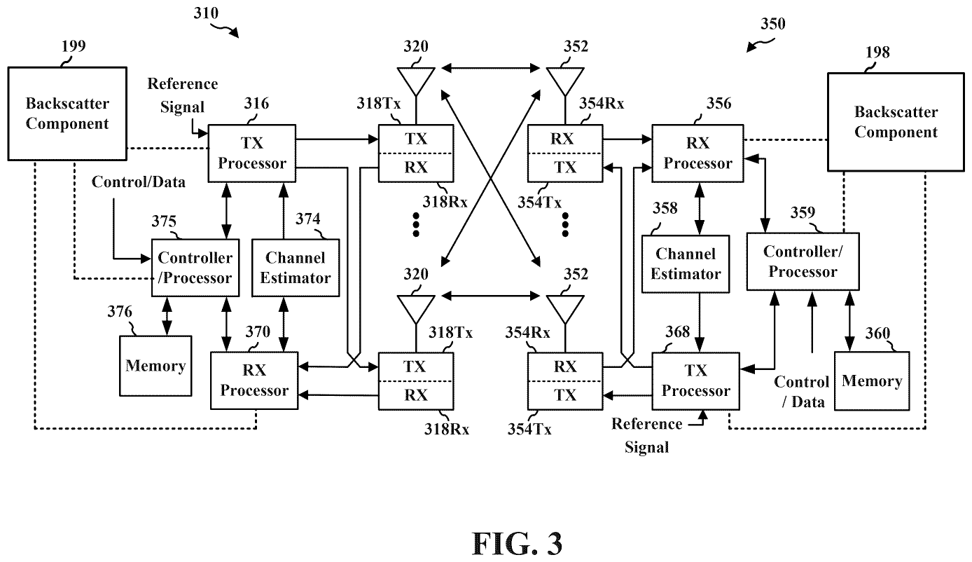

FIG. 3 is a block diagram of a base station 310 in communication with a UE 350 or other passive backscatter device, e.g., which may be referred to as a PUE, in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

Wireless communication networks, such as but not limited to a 5G NR network, may be designed to include configured grants (CGs) for UL transmissions. There may be different types of CG transmissions, such as dynamic grant-based UL data transmissions and CG-based UL data transmissions. As an example, a first type of CG, which may be referred to as a Type 1 CG, may be RRC activated. For example, the CG may be configured in RRC signaling, and a UE may use the resources of the CG based on the RRC configuration and without an additional activation. A second type of CG, which may be referred to as a Type 2 CG, may be DCI activated (e.g., without override of an RRC configuration, yet allowing for signal modulation and coding scheme (MCS) and available resources to be indicated in MAC-CE or DCI). For example, in the Type 2 CG, the resources for the CG may be indicated in an RRC configuration. However, the UE may wait until the CG is activated, e.g., by a MAC-CE, DCI, or other signaling, before transmitting data in the CG resources. The CG Type 1 may be RRC activated, and may be considered active once it is configured, and may be RRC deactivated, where the grant may be deactivated through RRC signaling that changes the configuration. The transmission parameters may be provided to the UE in RRC signaling. The CG Type 2 may be DCI activated after being provided in an RRC configuration, where a grant is active once an activation DCI is received, and DCI deactivated, where the grant may be deactivated once a deactivation DCI is received. For such a configuration, transmission parameters may be provided to the UE in RRC signaling, MAC-CE, and/or DCI.

Some IoT devices may be passive IoT devices (which may also be referred to as “ambient” IoT, an ambient device, a tag, a passive device, a backscatter device, etc.). Passive IoT may target ultra-low complexity (e.g., several orders of magnitude lower than enhanced machine-type communication (eMTC)/narrowband IoT (NB-IoT) and extremely low power consumption communication (e.g., few hundreds of uW) supporting Type-A and/or Type-B devices. Type-A devices may include batteryless (or zero-power) devices with little or no energy storage capability, while Type-B devices may include devices with energy storage (e.g., up to that available from ambient sources via energy harvesting) that may not need to be replaced or recharged manually. A passive IoT device (also referred to as a tag, a batteryless UE (BUE), and/or a passive UE (PUE)) may be passive devices not equipped with active RF components. For example, PUE may perform data transmission based on modulated backscatter of incident RF signals emitted by an ambient transmitter (e.g., cellular mobile devices or base stations). Ambient RF signals may serve as signal resources for backscattering, as well as energy resources for harvesting. RF identification (RF-ID) is an existing battery-less technology; however, the limited reading range of a few meters makes it difficult to support a large-scale deployment with seamless coverage based on this technology.

Some backscatter devices, such as RFID tags, may passively rely on a dedicated interrogator (or reader) to initiate communication. Tags may not be able to talk to a reader until they are directed to do so by the reader, e.g., the reader first sending a query command, and then the tag responding by modulating a backscattered signal. The query-response protocol may have similarities to dynamic grant scheduled UL transmissions where the query command can be viewed as a scheduling grant. However, in some aspects, however, issues may exist with using the query-response protocol for passive IoT devices. For example, a reader may frequently transmit commands based on the protocol in order to query whether any tag has data to transmit, which increases signaling overhead and decreases energy efficiency, e.g., for a UE-based reader. A passive IoT device may also be configured to support both mobile-terminated and mobile-originated traffic, and for the latter case, there may be an increase on latency if the passive IoT device cannot actively initiate communications to the reader.

Additionally, the existing configured grant mechanism may have complications if applied to passive IoT devices. For instance, a PUE may not maintain synchronization to a reader during configured grant transmission due to operation with intermittently available energy and interrupted connection. Further, due to mobility, a PUE may communicate with different readers, and accordingly, this switching of readers may include a dynamic activation and deactivation of the CG resources. In other words, more power may be consumed for passive IoT devices to continuously monitor the activation or deactivation DCI from a given reader based on a query-response protocol.

Aspects presented herein provide for more efficient wireless communication with a passive backscatter device. For example, a passive backscatter device may be configured to receive a configuration, e.g., from a reader or a network node such as a base station, for backscatter link resources and resources for a reference signal(s) associated with the backscatter link resources. The passive backscatter device may then receive a reference signal from the configured reference signal(s) associated with the backscatter link resources. In such aspects, the passive backscatter device may be configured to backscatter an information signal in a backscatter link resource from the configuration in response to receiving the reference signal. In aspects, the information signal may be or may include application layer data such as sensing data, or may be or include a layer 1/layer 2 (L1/L2) report, having, without limitation, tag side power state information, buffer status information, etc. Such an L1/L2 report may be used by a reader to select the reference signal for transmission and configure the corresponding backscatter link resources. The passive backscatter device may harvest energy from energy packets after the reference signal is received and/or between backscattering information signals in order to have power to backscatter the information signal in the previously configured resources. Thus, passive IoT devices are enabled to actively initiate communications to a reader via supporting backscatter transmissions on configured backscatter link resources (e.g., similar to a configured grant of backscatter link resources activated by the reception of the reference signal), are enabled to better support low latency mobile-originated traffic, and are enabled to reduce DL control overhead from a reader for passive IoT devices.

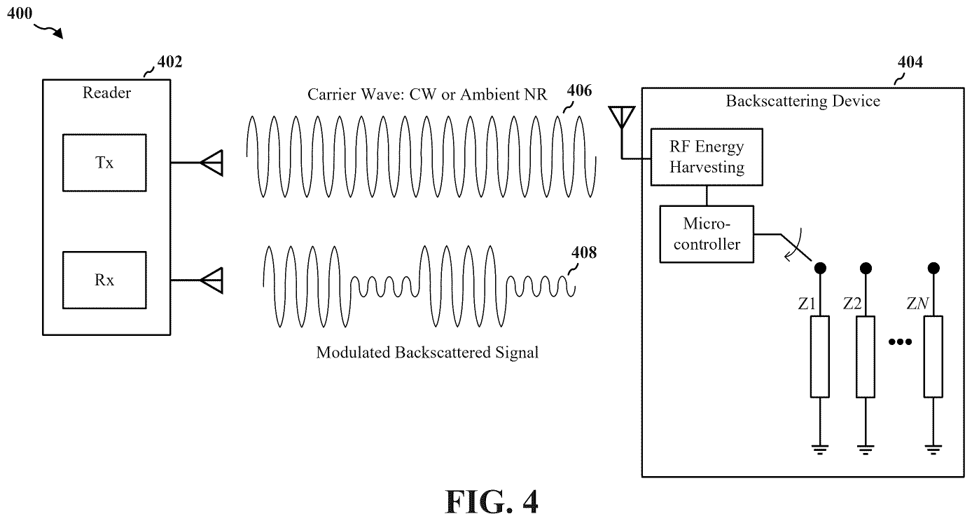

FIG. 4 is a diagram 400 illustrating example backscatter communications, in various aspects. Diagram 400 shows a reader 402, including a transmitter (Tx) with an associated antenna and a receiver (Rx) with an associated antenna, and a backscattering device 404, including an antenna, an RF energy harvesting component, a microcontroller, and a set of different load impedances. A reader may be a UE in some aspects. In other aspects, a reader may be a network node, such as a base station or a component of a base station. As illustrated, the reader 402 may transmit a carrier wave 406 (e.g., a continuous wave signal or an ambient NR signal) to the backscattering device 404. In backscatter communications, the information transmission may be performed by antenna modulation, which may not involve active RF generation. The backscattering device 404 may tune the reflection coefficient of its antenna by switching over a given set of impedances, e.g., as shown, resulting in a varying amount of incident signal to be backscattered. For instance, when using binary phase shift keying (BPSK) modulation, the backscattering device 404 may switch the value of the load impedance between a very high impedance and a relatively matched load. In the high impedance case, the mismatch between the antenna and load impedance may reflect all of the power back to the reader 402, while in the matched case, most of the power from the incoming RF signal may be absorbed and very little power may be reflected to the reader 402, as shown for a modulated backscattered signal 408. The impedance switching frequency may be based on the data rate.

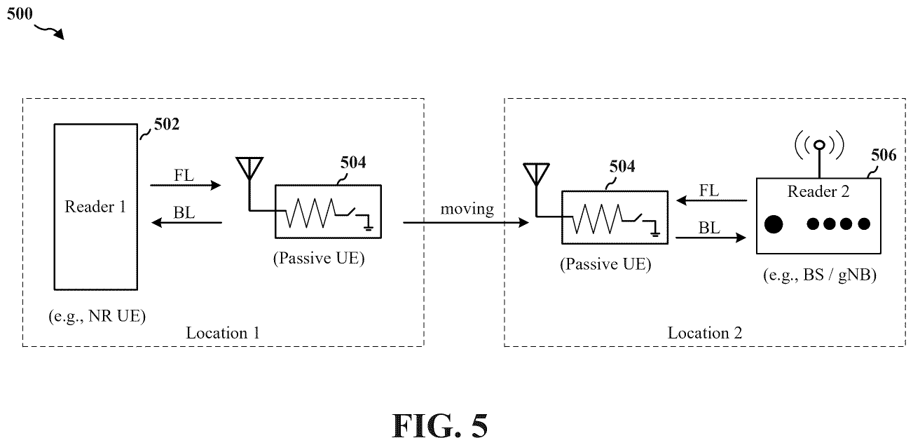

FIG. 5 is a diagram 500 illustrating an example of PUE mobility, in various aspects. Diagram 500 shows a first reader 502, e.g., a NR UE, communicating with a backscattering PUE 504 in a first location. The communicating may include a forward link and a backscatter link. The PUE 504 may, at some time, move to a location 2 in which it may communicate with a second reader 506 (e.g., a base station, gNB, another UE, etc.) over similar links. As existing CG mechanisms may have challenges in being applied to passive IoT devices, e.g., the backscattering PUE 504, this PUE may not maintain synchronization to the first reader 502 during configured grant transmission due to operation with intermittently available energy and interrupted connection, and due to mobility, as shown, the PUE 504 may communicate with different readers, such as the second reader 506. The illustrated switching from the first reader 502 to the second reader 506, due to mobility of the PUE 504, may include a dynamic activation and deactivation of CG resources, which may lead to more power consumption for the PUE 504 to continuously monitor the activation or deactivation DCI from each given reader.

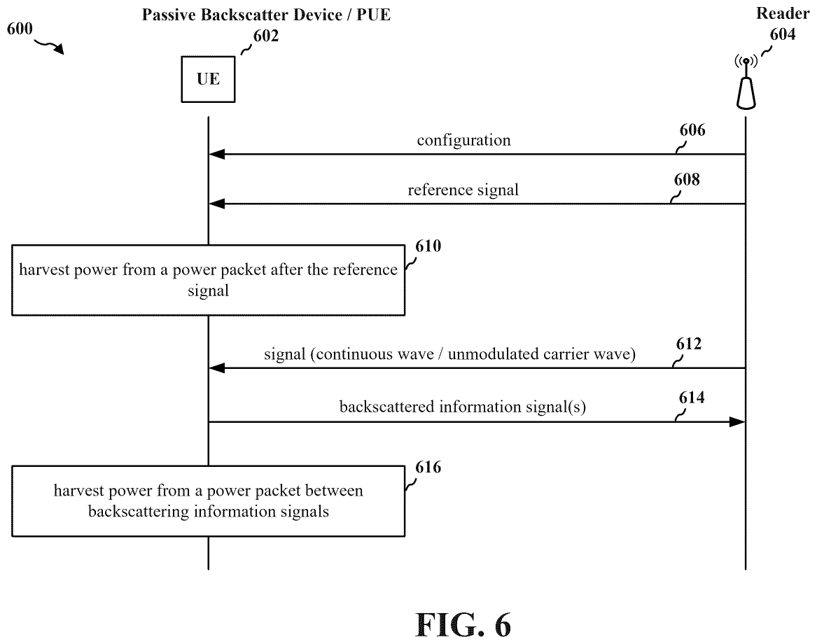

FIG. 6 shows a call flow diagram 600 for wireless communications, in various aspects. Call flow diagram 600 illustrates backscattering data transmissions on configured resources in wireless communications, and illustrates configuring a passive backscattering device 602 (hereinafter “PUE 602”) for such aspects via configurations from a reader 604 (e.g., a base station or portion thereof, such as a gNB or other type of base station, a NR UE, etc., by way of example), in various aspects. Aspects described for the reader 604 may be performed by the reader in aggregated form and/or by one or more components of the reader in disaggregated form (e.g., for base station configurations). Additionally, or alternatively, the backscattering data transmissions on configured resources may be performed by the PUE 602 autonomously, in addition to, and/or in lieu of, configurations provided to the PUE 602 from the reader 604.

In the illustrated aspect, the PUE 602 may receive a configuration 606 for backscatter link resources and resources for a reference signal(s) associated with the backscatter link resources. In some aspects, the PUE 602 may receive the configuration 606 from the reader 604. In other aspects, the PUE 602 may receive the configuration 606 from a network node, such as a base station or component of a base station, which may be separate from the reader 604. In some aspects, the configuration 606 may include backscatter link resources and/or a reference signal configuration for backscattering information signals with multiple readers. The configuration 606 may include multiple reference signals that are dedicated for the PUE 602 (e.g., as a passive backscatter device). In some aspects, the configuration 606 may include multiple references signals. In such aspects, the multiple reference signals may be dedicated for the passive backscatter device or each reference signal may be associated with one of multiple readers.

The PUE 602 may also be configured to receive, from the reader 604, a reference signal 608. As noted above, the configuration 606 may include resources for a reference signal(s) associated with the backscatter link resources, and the reference signal 608 may be a reference signal from the reference signal(s) associated with the backscatter link resources. In some aspects, the reference signal 608 may include a group common reference signal having multiple associated backscatter link resources. In such aspects, the PUE 602 may be configured to select a backscatter link resource from the multiple associated backscatter link resources. In some aspects, the reader 604 may be configured to select the reference signal 608 based on a transmission strategy to provide an energy packet to power the PUE 602. In such aspects, the transmission strategy of the reader 604 may be associated with a report from the PUE 602 on its buffer status, power state, etc. In another example, if the reader 604 is capable of transmitting or providing the energy signal more frequently, the reader 604 may select the reference signal 608 as corresponding to the backscatter link resource with a small periodicity and large transmission duration (e.g., as compared to other backscatter link resources).

The PUE 602 may be configured, at 610, to harvest power from an energy packet after the reference signal 608. For example, the reader 604 may be configured to transmit or provide an energy packet(s) to the PUE 602 after the triggering reference signal. The PUE 602 may be configured to work in an energy harvesting mode when not receiving the reference signal 608, and in such cases, the energy of the incident RF signal may be fully harvested by the PUE 602 without reflection.

The PUE 602 may be configured to receive, from the reader 604, a signal 612 that may be a continuous wave signal or an unmodulated carrier wave signal. The signal 612 may be received after the reference signal 608, and an information signal 614, described further below, may be based on the signal 612 (e.g., a continuous wave signal or a unmodulated carrier wave signal). The signal 612 may be reflected or backscattered by the PUE 602 back to the reader 604 to transmit information—that is, the information signal 614 may be backscattered by the PUE 602 in a backscatter link resource from the configuration 606 in response to receiving the reference signal 608. In aspects, the PUE 602 may be configured to backscatter the information signal 614 to the reader 604 using one or more transmission parameters based on the reference signal 608 from the multiple reference signals. In aspects, the one or more transmission parameters may include at least one of: a scheduling delay, a number of backscattering resource occasions, a backscattering interval, modulation format, a coding scheme, a coding rate, transmission duration, and/or a frequency for switching antenna reflection coefficient. In other configurations, the PUE 602 may be configured to: backscatter the information signal 614 on a number of semi-persistent backscatter link resources and with a resource periodicity that is dependent on the reference signal 608, backscatter the information signal 614 to the reader 604 associated with the reference signal 608 received by the PUE 602 (e.g., a passive backscatter device), and/or backscatter the information signal 614 a number of times, e.g., including more than one time, based on a signal strength of the reference signal 608.

The PUE 602 may be further configured, at 616, to harvest power from an energy packet between backscattering information signals. For example, the reader 604 may be configured to transmit or provide an energy packet(s) to the PUE 602 in between any two backscatter transmissions, e.g., the signal 612, for the PUE 602 to harvest energy for subsequent backscattering, e.g., additional backscattered information signals 612. The PUE 602 may thus also be configured to work in an energy harvesting mode when not transmitting by backscattering, e.g., information signal(s) 614, and in such cases the energy of the incident RF signal may be fully harvested by the PUE 602 without reflection.

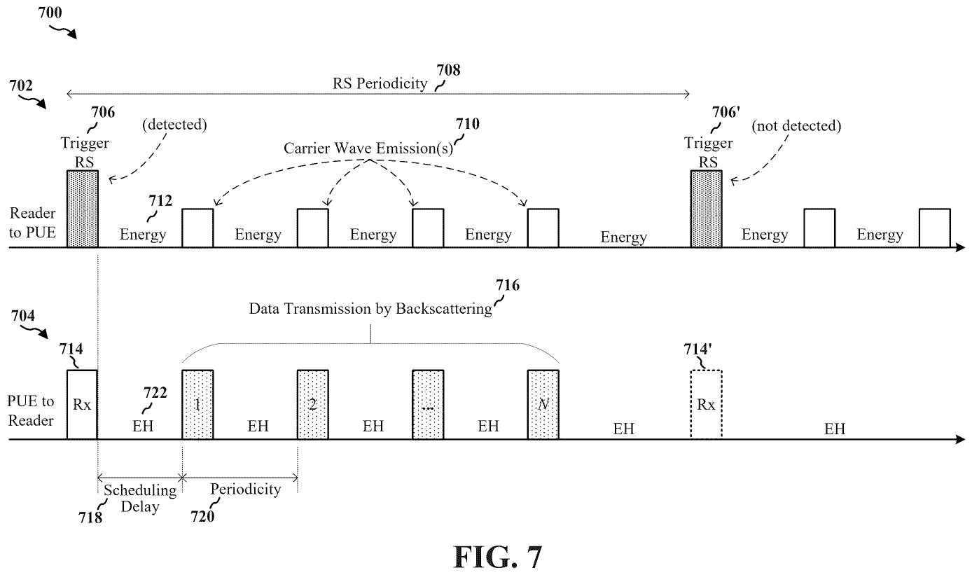

FIG. 7 is a diagram 700 illustrating example backscatter transmissions on configured UL resources, in various aspects. Diagram 700 shows a reader to PUE configuration 702 and a PUE to reader configuration 704 for such aspects, with respect to time.

The described backscattering data transmissions on configured resources may utilize periodically transmitted trigger reference signals (RS) 706/706′/etc. (e.g., analogous to a low-power wake up signal (LP-WUS)), to trigger a backscatter transmission of information on configured UL resources, as shown for configuration 702. The trigger reference signals 706/706′/etc., may be transmitted or provided on periodic resources, but the actual transmitted reference signal may be different, e.g., either group-common or UE dedicated based on the configuration or other factors. Also shown is a periodicity 708 between instances of the trigger reference signals 706/706′/etc., and a notation that the trigger reference signal 706 is detected, while the trigger reference signal 706′ is not detected, as described in further detail below.

In some aspects, the one or multiple trigger reference signals 706/706′/etc., may include at least one group common reference signal which may trigger a contention-based backscattering transmission of information. For example, a group-common reference signal may be associated with multiple transmission occasions, and a PUE may randomly select or use a predetermined rule considering the PUE identifier (e.g., similar to paging frame/paging occasion (PF/PO) determinations for paging) to select a transmission occasion for backscattering transmission of information. In some aspects, the one or multiple trigger reference signals 706/706′/etc., may include one or multiple UE dedicated reference signals which may trigger a contention-free backscattering transmission of information. For example, each UE dedicated reference signal may be associated with different resource parameters (e.g., scheduling delay, number of occasions, interval, etc.) and backscatter transmission parameters (e.g., modulation format, coding scheme, impedance switching frequency, etc.). Transmission parameters such as impedance switching frequency may also be implicitly based on the resources (e.g., a resource with long scheduling delay or large interval may be associated with a high switching frequency as the long scheduling delay or large transmission interval may imply that more energy can be harvested to afford more power consumption for high data rate transmissions). In some aspects, the one or multiple trigger reference signals 706/706′/etc., may be associated with different readers and in such cases, the PUE may be aware of a change of the reader, e.g., due to PUE mobility, based on the detected reference signal. In response to detection of a change of reader, the PUE may firstly transmit an ACK signal for validation of configured UL resources, and then perform backscattered data transmission based on further response from the reader.

Still referring to the configuration 702, the reader may provide the trigger reference signal 706 for the PUE, and also may subsequently provide one or more carrier wave emissions 710. After transmitting the trigger reference signal 706, the reader may be expected to transmit or provide a continuous wave or an unmodulated carrier wave signal on the configured UL resources to the PUE. The continuous wave may be used as the signal resource to be reflected by PUE. For instance, the carrier wave emission(s) 710 may be continuous wave signals or may be unmodulated carrier wave signals, in aspects, and as described herein, the carrier wave emission(s) 710 may be utilized by the PUE for backscattering of information (e.g., as information signals). The reader may repeat provision of a reference signal for the PUE, as illustrated by the trigger reference signal 706′, which may be followed by an additional carrier wave emission(s) 710 and energy packets 712. As shown, between the trigger reference signals 706/706′/etc., and the carrier wave emission(s) 710, may be one or more energy packets 712, which may be provided by the reader to power the PUE.

Referring to the configuration 704, the PUE may have a reception 714 (Rx) of the provided trigger reference signal 706, subsequent to which one or more instances of data transmission by backscattering 716 may take place, shown as instances 1, 2, . . . , N, which may correspond to the carrier wave emission(s) 710 in configuration 702 with a periodicity 720. Likewise, a reception 714′ (Rx) occasion of the provided trigger reference signal 706′ is shown. The instances of data transmission by backscattering 716 may be started after a scheduling delay 718 (e.g., fixed or configurable) from the end of the trigger reference signal 706, and the instances of data transmission by backscattering 716 may be one-shot or multi-shots based on configuration or indication, where multi-shot instances may have the periodicity 720. It should be noted that reception 714′ occasion is not followed by instances of data transmission by backscattering 716 as the trigger reference signal 706′ is “not detected.” As shown, between the receptions 714/714′/etc., and the instances of data transmission by backscattering 716, corresponding to the energy packets 712 provided the reader, the PUE may perform energy harvesting (EH) 722 in a EH mode.

In some aspects, the PUE may be configured to transmit an indication of early termination for the information signal to the reader, where the early termination may be based on an available energy at the PUE, and to stop backscatter of the information signal before a configured transmission number, where the reader is also configured to stop reception of the information signal before the configured transmission number. Early termination may include the actual number of transmissions being lower than the configured or indicated maximum value. The early termination indicator may be based on a specific preamble preceding the payload or a flag format inserted at the end of frame.

In some aspects, the reader may configure a power threshold which may be used by the PUE to evaluate the DL channel quality to validate the backscattering transmission of information. The reader may be configured to provide the power threshold, e.g., to the PUE, where the backscatter link resource in which the backscattered information signal is received is based on a measurement of the reference signal meeting the power threshold. In some aspects, the PUE may be configured to skip backscattering the information signal, e.g., skip further backscattering of the information signal, based on a condition that a received signal strength of the reference signal is below a threshold. The backscattering transmission of information on a configured UL resource may be allowed when the received signal strength is above the power threshold.

In some aspects, when the reader does not receive any backscattered signal on the configured resource for a continuous number of reference signal transmission occasions, the reader may assume the PUE to be out of coverage, and the reader may release the configured UL resources and may not transmit the reference signal on the periodic resources. The reader may be configured to transmit or provide a number of consecutive reference signal transmissions to the PUE, and to identify the PUE as being out of coverage on a condition of no response being received to the number of consecutive reference signal transmissions. In such aspects, the reader may be configured to release the backscatter link resources of the configuration based on the PUE being out of the coverage. In such cases, the PUE may re-access a reader to re-establish a communications link.

In cases of bi-static deployment (e.g., the reader transmitter and receiver being decoupled to two separate nodes), the trigger reference signals 706/706′/etc., may also activate the reader's receiver to receive the backscatter transmission of information from the PUE.

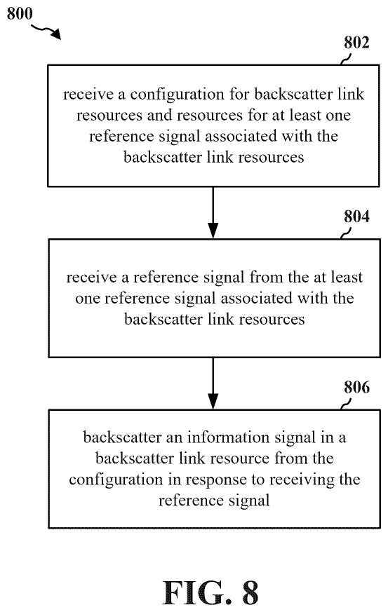

FIG. 8 is a flowchart 800 of a method of wireless communication. The method may be performed by a passive backscatter device (e.g., the PUE 602; the passive backscatter apparatus). At 802, the passive backscatter device is configured to receive a configuration for backscatter link resources and resources for at least one reference signal associated with the backscatter link resources. In aspects, 802 may be performed by component 198. For instance, and with reference to FIGS. 6, 7, the PUE 602 may be configured to receive, from the reader 604, a configuration 606. The configuration 606 may be for backscatter link resources and periodic resources for a reference signal(s) 608 (e.g., 706, 706′ in FIG. 7) associated with the backscatter link resources. The configuration 606 may include multiple reference signals 608 (e.g., 706, 706′ in FIG. 7) that are dedicated for the PUE 602 (e.g., as a passive backscatter device). In some aspects, the configuration 606 may include multiple references signals 608 (e.g., 706, 706′ in FIG. 7). In such aspects, the multiple reference signals 608 (e.g., 706, 706′ in FIG. 7) may be dedicated for the passive backscatter device (PUE 602) or each reference signal may be associated with one of multiple readers (e.g., 604).

At 804, the passive backscatter device is configured to receive a reference signal from the at least one reference signal associated with the backscatter link resources. In aspects, 804 may be performed by component 198. For instance, and with reference to FIGS. 6, 7, the PUE 602 may be configured to receive the reference signal 608 (e.g., 706, 706′ in FIG. 7) from the reader 604. As noted above, the configuration 606 may include periodic resources for a reference signal(s) associated with the backscatter link resources, and the reference signal 608 (e.g., 706, 706′ in FIG. 7) may be a reference signal from the reference signal(s) associated with the backscatter link resources. In aspects, the reference signal 608 (e.g., 706, 706′ in FIG. 7) may include a group common reference signal having multiple associated backscatter link resources. In such aspects, the PUE 602 may be configured to select the backscatter link resource from the multiple associated backscatter link resources. In some aspects, the reader 604 may be configured to select the reference signal 608 (e.g., 706, 706′ in FIG. 7) based on a transmission strategy to provide an energy packet to power the PUE 602. In such aspects, the transmission strategy of the reader 604 may be associated with a report from the PUE 602 on its buffer status, power state, etc.

At 806, the passive backscatter device is configured to backscatter an information signal in a backscatter link resource from the configuration in response to receiving the reference signal. In aspects, 806 may be performed by component 198. For instance, and with reference to FIGS. 6, 7, the PUE 602 may be configured to transmit the backscattered, information signal 614 (e.g., 716 in FIG. 7) that may be reflected or backscattered by the PUE 602 back to the reader 604 to transmit information. The information signal 614 (e.g., 716 in FIG. 7) may be backscattered by the PUE 602 in a backscatter link resource from the configuration 606 in response to receiving the reference signal 608 (e.g., 706, 706′ in FIG. 7). In aspects, the PUE 602 may be configured to backscatter the information signal 614 (e.g., 716 in FIG. 7) to the reader 604 using one or more transmission parameters based on the reference signal 608 (e.g., 706, 706′ in FIG. 7) from the multiple reference signals. In aspects, the one or more transmission parameters may include at least one of: a scheduling delay, a number of backscattering resource occasions, a backscattering interval, modulation format, a coding scheme, a coding rate, transmission duration, and/or a frequency for switching antenna reflection coefficient. In other configurations, the PUE 602 may be configured to: backscatter the information signal 614 (e.g., 716 in FIG. 7) on a number of semi-persistent backscatter link resources and with a resource periodicity that is dependent on the reference signal 608 (e.g., 706, 706′ in FIG. 7), backscatter the information signal 614 (e.g., 716 in FIG. 7) to the reader 604 associated with the reference signal 608 (e.g., 706, 706′ in FIG. 7) received by the PUE 602 (e.g., a passive backscatter device), and/or backscatter the information signal 614 (e.g., 716 in FIG. 7) a number of times, e.g., including more than one time, based on a signal strength of the reference signal 608 (e.g., 706, 706′ in FIG. 7).

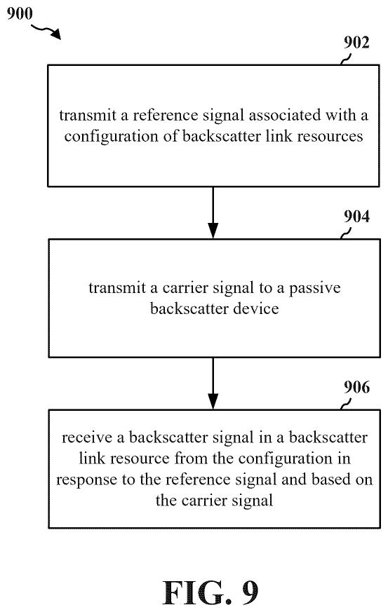

FIG. 9 is a flowchart 900 of a method of wireless communication. The method may be performed by a reader such as the reader 604, a UE (e.g., the UE 104; the apparatus 1004) or a base station (e.g., the base station 102; the network entity 1002, 1102). At 902, the reader is configured to transmit a reference signal associated with a configuration of backscatter link resources. In some aspects, 902 may be performed by component 199. For instance, with reference to FIGS. 6, 7, the reader 604 may be configured to transmit or provide the reference signal 608 (e.g., 706, 706′ in FIG. 7) to the PUE 602. As noted above, the configuration 606 may include periodic resources for a reference signal(s) associated with the backscatter link resources, and the reference signal 608 (e.g., 706, 706′ in FIG. 7) may be a reference signal from the reference signal(s) associated with the backscatter link resources. In aspects, the reference signal 608 (e.g., 706, 706′ in FIG. 7) may include a group common reference signal having multiple associated backscatter link resources. In such aspects, the PUE 602 may be configured to select the backscatter link resource from the multiple associated backscatter link resources. In some aspects, the reader 604 may be configured to select the reference signal 608 (e.g., 706, 706′ in FIG. 7) based on a transmission strategy to provide an energy packet to power the PUE 602. In such aspects, the transmission strategy of the reader 604 may be associated with a report from the PUE 602 on its buffer status, power state, etc.

At 904, the reader is configured to transmit a carrier signal to a passive backscatter device. In some aspects, 904 may be performed by component 199. For instance, with reference to FIGS. 6, 7, the reader 604 may be configured to transmit or provide the signal 612 (e.g., 710 in FIG. 7) to the PUE 602. The PUE 602 may be configured to receive, as provided by the reader 604, the signal 612 (e.g., 710 in FIG. 7) that may be a continuous wave signal or an unmodulated carrier wave signal. The signal 612 (e.g., 710 in FIG. 7) may be provided by the reader 604 after the reference signal 608 (e.g., 706, 706′ in FIG. 7), and an information signal 614, described herein, may be based on the signal 612 (e.g., 710 in FIG. 7), e.g., a continuous wave signal or a unmodulated carrier wave signal. The signal 612 (e.g., 710 in FIG. 7) may be reflected or backscattered by the PUE 602 back to the reader 604 to transmit information.

Finally, at 906, the reader is configured to receive a backscatter signal in a backscatter link resource from the configuration in response to the reference signal and based on the carrier signal. In some aspects, 906 may be performed by component 199. For instance, with reference to FIGS. 6, 7, the reader 604 may be configured to receive, from the PUE 602, the backscattered, information signal 614 (e.g., 716 in FIG. 7) that may be reflected or backscattered by the PUE 602 back to the reader 604 to transmit information. The information signal 614 (e.g., 716 in FIG. 7) may be backscattered by the PUE 602 in a backscatter link resource from the configuration 606 in response to receiving the reference signal 608 (e.g., 706, 706′ in FIG. 7). In aspects, the PUE 602 may be configured to backscatter the information signal 614 (e.g., 716 in FIG. 7) to the reader 604 using one or more transmission parameters based on the reference signal 608 (e.g., 706, 706′ in FIG. 7) from the multiple reference signals. In aspects, the one or more transmission parameters may include at least one of: a scheduling delay, a number of backscattering resource occasions, a backscattering interval, modulation format, a coding scheme, a coding rate, transmission duration, and/or a frequency for switching antenna reflection coefficient. In other configurations, the PUE 602 may be configured to: backscatter the information signal 614 (e.g., 716 in FIG. 7) on a number of semi-persistent backscatter link resources and with a resource periodicity that is dependent on the reference signal 608 (e.g., 706, 706′ in FIG. 7), backscatter the information signal 614 (e.g., 716 in FIG. 7) to the reader 604 associated with the reference signal 608 (e.g., 706, 706′ in FIG. 7) received by the PUE 602 (e.g., a passive backscatter device), and/or backscatter the information signal 614 (e.g., 716 in FIG. 7) a number of times, e.g., including more than one time, based on a signal strength of the reference signal 608 (e.g., 706, 706′ in FIG. 7).

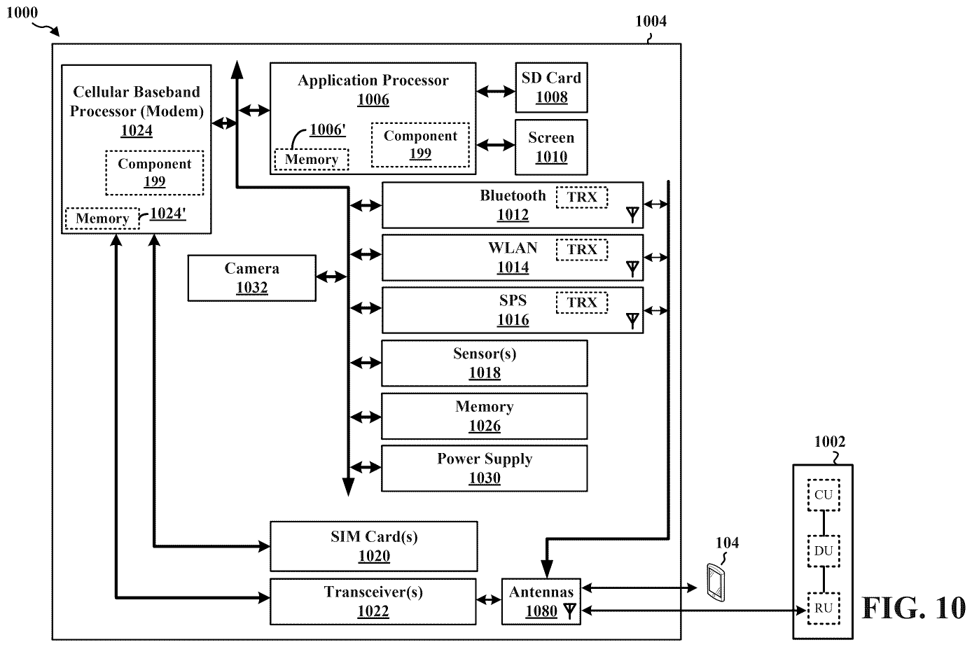

FIG. 10 is a diagram 1000 illustrating an example of a hardware implementation for a reader apparatus 1004. The apparatus 1004 may be a UE, a component of a UE, or may implement UE functionality. In some aspects, the apparatus 1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described supra. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see UE 350 of FIG. 3) and include the additional modules of the apparatus 1004.

As discussed supra, the component 199 may be configured to transmit a reference signal associated with a configuration of backscatter link resources; transmit a carrier signal to a passive backscatter device; and receive a backscatter signal in an backscatter link resource from the configuration in response to the reference signal and based on the carrier signal. The component 199 may be further configured to select the reference signal based on a transmission strategy to provide an energy packet to power the passive backscatter device. The component 199 may be further configured to provide the configuration for the backscatter link resources and periodic resources for at least one reference signal associated with the backscatter link resources. The component 199 may be further configured to provide a continuous wave signal or an unmodulated carrier wave signal after the reference signal, where the backscatter signal is based on the continuous wave signal or the unmodulated carrier wave signal. The component 199 may be further configured to provide an energy packet after the reference signal or between backscattering information signals to provide power to be harvested by the passive backscatter device. The component 199 may be further configured to provide a power threshold, wherein the backscatter link resource in which the backscatter signal is received is based on a measurement of the reference signal meeting the power threshold. The component 199 may be further configured to receive an indication of early termination for the backscatter signal, the early termination being based on available energy at the passive backscatter device; and stop reception of the backscatter signal before a configured transmission number. The component 199 may be further configured to transmit a number of consecutive reference signal transmissions to the passive backscatter device; and identify the passive backscatter device as being out of coverage on a condition of no response being received to the number of consecutive reference signal transmissions. The component 199 may be further configured to release the backscatter link resources of the configuration based on the passive backscatter device being out of the coverage. The component 199 may be within the cellular baseband processor 1024, the application processor 1006, or both the cellular baseband processor 1024 and the application processor 1006. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, may include means for transmitting a reference signal associated with a configuration of backscatter link resources; means for transmitting a carrier signal to a passive backscatter device; and means for receiving a backscatter signal in an backscatter link resource from the configuration in response to the reference signal and based on the carrier signal. The apparatus may further include means for selecting the reference signal based on a transmission strategy to provide an energy packet to power the passive backscatter device. The apparatus may further include means for providing the configuration for the backscatter link resources and periodic resources for at least one reference signal associated with the backscatter link resources. The apparatus may further include means for providing a continuous wave signal or an unmodulated carrier wave signal after the reference signal, wherein the backscatter signal is based on the continuous wave signal or the unmodulated carrier wave signal. The apparatus may further include means for providing an energy packet after the reference signal or between backscattering information signals to provide power to be harvested by the passive backscatter device. The apparatus may further include means for providing a power threshold, wherein the backscatter link resource in which the backscatter signal is received is based on a measurement of the reference signal meeting the power threshold. The apparatus may further include means for receiving an indication of early termination for the backscatter signal, the early termination being based on available energy at the passive backscatter device; and means for stopping reception of the backscatter signal before a configured transmission number. The apparatus may further include means for transmitting a number of consecutive reference signal transmissions to the passive backscatter device; and means for identifying the passive backscatter device as being out of coverage on a condition of no response being received to the number of consecutive reference signal transmissions. The apparatus may further include means for releasing the backscatter link resources of the configuration based on the passive backscatter device being out of the coverage. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

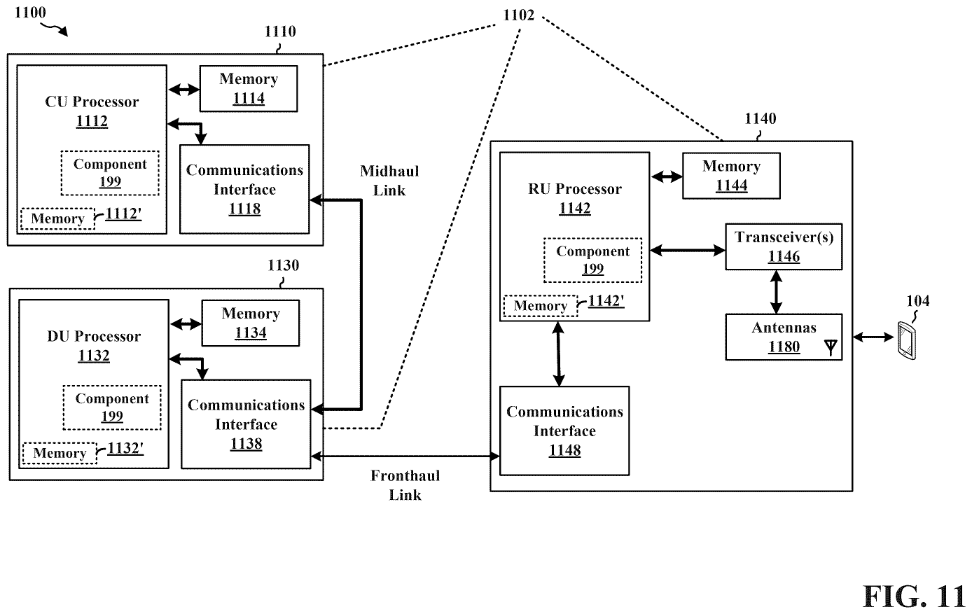

FIG. 11 is a diagram 1100 illustrating an example of a hardware implementation for reader device. The reader device may be a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

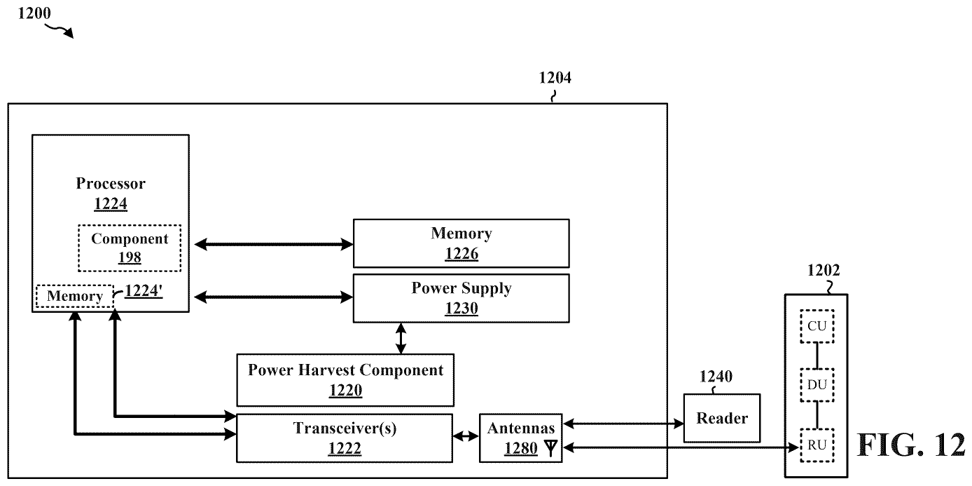

As discussed supra, the component 199 may be configured to transmit a reference signal associated with a configuration of backscatter link resources; transmit a carrier signal to a passive backscatter device; and receive a backscatter signal in an backscatter link resource from the configuration in response to the reference signal and based on the carrier signal. The component 199 may be further configured to select the reference signal based on a transmission strategy to provide an energy packet to power the passive backscatter device. The component 199 may be further configured to provide the configuration for the backscatter link resources and periodic resources for at least one reference signal associated with the backscatter link resources. The component 199 may be further configured to provide a continuous wave signal or an unmodulated carrier wave signal after the reference signal, where the backscatter signal is based on the continuous wave signal or the unmodulated carrier wave signal. The component 199 may be further configured to provide an energy packet after the reference signal or between backscattering information signals to provide power to be harvested by the passive backscatter device. The component 199 may be further configured to provide a power threshold, wherein the backscatter link resource in which the backscatter signal is received is based on a measurement of the reference signal meeting the power threshold. The component 199 may be further configured to receive an indication of early termination for the backscatter signal, the early termination being based on available energy at the passive backscatter device; and stop reception of the backscatter signal before a configured transmission number. The component 199 may be further configured to transmit a number of consecutive reference signal transmissions to the passive backscatter device; and identify the passive backscatter device as being out of coverage on a condition of no response being received to the number of consecutive reference signal transmissions. The component 199 may be further configured to release the backscatter link resources of the configuration based on the passive backscatter device being out of the coverage. The component 199 may be within one or more processors of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 may include means for transmitting a reference signal associated with a configuration of backscatter link resources; means for transmitting a carrier signal to a passive backscatter device; and means for receiving a backscatter signal in an backscatter link resource from the configuration in response to the reference signal and based on the carrier signal. The network entity may further include means for selecting the reference signal based on a transmission strategy to provide an energy packet to power the passive backscatter device. The network entity may further include means for providing the configuration for the backscatter link resources and periodic resources for at least one reference signal associated with the backscatter link resources. The network entity may further include means for providing a continuous wave signal or an unmodulated carrier wave signal after the reference signal, wherein the backscatter signal is based on the continuous wave signal or the unmodulated carrier wave signal. The network entity may further include means for providing an energy packet after the reference signal or between backscattering information signals to provide power to be harvested by the passive backscatter device. The network entity may further include means for providing a power threshold, wherein the backscatter link resource in which the backscatter signal is received is based on a measurement of the reference signal meeting the power threshold. The network entity may further include means for receiving an indication of early termination for the backscatter signal, the early termination being based on available energy at the passive backscatter device; and means for stopping reception of the backscatter signal before a configured transmission number. The network entity may further include means for transmitting a number of consecutive reference signal transmissions to the passive backscatter device; and means for identifying the passive backscatter device as being out of coverage on a condition of no response being received to the number of consecutive reference signal transmissions. The network entity may further include means for releasing the backscatter link resources of the configuration based on the passive backscatter device being out of the coverage. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means. FIG. 12 is a diagram 1200 illustrating an example of a hardware implementation for a passive backscatter apparatus 1204. In some aspects, the apparatus 1204 may include a processor 1224 coupled to one or more transceivers 1222 (e.g., backscattering transceivers). The processor 1224 may include on-chip memory 1224′. The apparatus 1204 may include additional memory modules 1226, a power supply 1230, and a power harvest component 1220 that harvests ambient power, such as from a wireless signal to store in the power supply 1230 in order to backscatter information signals to a reader 1240. The Bluetooth module 1012, the WLAN module 1014, and the SPS module 1016 may include an on-chip transceiver (TRX) (or in some cases, just a receiver (RX)). The apparatus 1204 includes one or more antennas 1280 for receiving a continuous wave, an unmodulated carrier wave signal, or an energy packet. The processor 1224 receives the signal and backscatters an information signal through the transceiver(s) 1222 via one or more antennas 1280 with the reader 1240 and/or with an RU associated with a network entity 1202. The processor 1224 may include a computer-readable medium/memory 1224′. The additional memory modules 1226 may also be considered a computer-readable medium/memory. Each computer-readable medium/memory 1224′, 1226 may be non-transitory. The processor 1224 may be responsible for general processing, including the execution of software stored on the computer-readable medium/memory. The software, when executed by the processor 1224/application processor 1206, causes the processor 1224 to perform the various functions described supra. The computer-readable medium/memory may also be used for storing data that is manipulated by the processor 1024 when executing software.

As discussed supra, the component 198 may be configured to receive a configuration for backscatter link resources and periodic resources for at least one reference signal associated with the backscatter link resources; receive a reference signal from the at least one reference signal associated with the backscatter link resources; and backscatter an information signal in a backscatter link resource from the configuration in response to receiving the reference signal. The component 198 may be further configured to select the backscatter link resource from the multiple associated backscatter link resources. The component 198 may be further configured to receive a continuous wave signal or an unmodulated carrier wave signal after the reference signal, wherein the information signal is backscattered based on the continuous wave signal or the unmodulated carrier wave signal. The component 198 may be further configured to harvest power from an energy packet after the reference signal or between backscattering information signals. The component 198 may be further configured to transmit an indication of early termination for the information signal, the early termination being based on available energy at the passive backscatter device; and stop transmission of the information signal before a configured transmission number. The component 198 may be further configured to transmit the information signal a number of times based on a signal strength of the reference signal. The component 198 may be further configured to skip backscattering the information signal based on a condition that a received signal strength of the reference signal is below a threshold. The component 198 may be within the processor 1224. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1004, and in particular the processor 1224 and/or the application processor 1206, may include means for receiving a configuration for backscatter link resources and periodic resources for at least one reference signal associated with the backscatter link resources; means for receiving a reference signal from the at least one reference signal associated with the backscatter link resources; and means for backscattering an information signal in a backscatter link resource from the configuration in response to receiving the reference signal. The apparatus may further include means for selecting the backscatter link resource from the multiple associated backscatter link resources. The apparatus may further include means for receiving a continuous wave signal or an unmodulated carrier wave signal after the reference signal, wherein the information signal is backscattered based on the continuous wave signal or the unmodulated carrier wave signal. The apparatus may further include means for harvesting power from an energy packet after the reference signal or between backscattering information signals. The apparatus may further include means for transmitting an indication of early termination for the information signal, the early termination being based on available energy at the passive backscatter device; and means for stopping transmission of the information signal before a configured transmission number. The apparatus may further include means for transmitting the information signal a number of times based on a signal strength of the reference signal. The apparatus may further include means for skipping backscattering the information signal based on a condition that a received signal strength of the reference signal is below a threshold. The means may be the component 198 of the apparatus 1204 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a passive backscatter device, comprising: receiving a configuration for backscatter link resources and periodic resources for at least one reference signal associated with the backscatter link resources; receiving a reference signal from the at least one reference signal associated with the backscatter link resources; and backscattering an information signal in a backscatter link resource from the configuration in response to receiving the reference signal.

Aspect 2 is the method of aspect 1, where the reference signal comprises a group common reference signal having multiple associated backscatter link resources, the method further comprising: selecting the backscatter link resource from the multiple associated backscatter link resources.

Aspect 3 is the method of any of aspects 1 and 2, where the configuration includes multiple reference signals that are dedicated for the passive backscatter device, where backscattering the information signal includes: backscattering the information signal to a reader using one or more transmission parameters based on the reference signal from the multiple reference signals.

Aspect 4 is the method of aspect 3, where the one or more transmission parameters include at least one of: a scheduling delay, a number of backscattering resource occasions, a backscattering interval, a modulation format, a coding scheme, a coding rate, a transmission duration, or a frequency for switching antenna reflection coefficient.

Aspect 5 is the method of any of aspects 1 and 2, where backscattering the information signal includes: backscattering the information signal on a number of semi-persistent backscatter link resources and with a resource periodicity that is dependent on the reference signal.

Aspect 6 is the method of any of aspects 1 and 2, where the configuration includes multiple references signals, each reference signal associated with one of multiple readers, and where backscattering the information signal includes: backscattering the information signal to a reader associated with the reference signal received by the passive backscatter device.

Aspect 7 is the method of any of aspects 1 to 6, further comprising: receiving a continuous wave signal or an unmodulated carrier wave signal after the reference signal, where the information signal is based on the continuous wave signal or the unmodulated carrier wave signal.

Aspect 8 is the method of any of aspects 1 to 7, further comprising: harvesting power from an energy packet after the reference signal or between backscattering information signals.

Aspect 9 is the method of any of aspects 1 to 8, further comprising: transmitting an indication of early termination for the information signal, the early termination being based on an available energy at the passive backscatter device; and stopping backscatter of the information signal before a configured transmission number.

Aspect 10 is the method of any of aspects 1 to 2 and 7 to 9, where backscattering the information signal includes: backscattering the information signal a number of times based on a signal strength of the reference signal.

Aspect 11 is the method of aspect 10, where backscattering the information signal includes: skipping backscattering the information signal based on a condition that a received signal strength of the reference signal is below a threshold.

Aspect 12 is a method of wireless communication at a reader, comprising: transmitting a reference signal associated with a configuration of backscatter link resources; transmitting a carrier signal to a passive backscatter device; and receiving a backscatter signal in an backscatter link resource from the configuration in response to the reference signal and based on the carrier signal.

Aspect 13 is the method of aspect 12, further comprising: selecting the reference signal based on a transmission strategy to provide an energy packet to power the passive backscatter device.

Aspect 14 is the method of any of aspects 12 and 13, further comprising: providing the configuration for the backscatter link resources and periodic resources for at least one reference signal associated with the backscatter link resources.

Aspect 15 is the method of any of aspects 12 to 14, where the reference signal comprises a group common reference signal having multiple associated backscatter link resources, where the backscatter signal is received in the backscatter link resource from the multiple associated backscatter link resources.

Aspect 16 is the method of any of aspects 12 to 15, where the configuration includes multiple reference signals that are dedicated for the passive backscatter device, where receiving the backscatter signal includes: receiving the backscatter signal having one or more transmission parameters based on the reference signal from the multiple reference signals.

Aspect 17 is the method of aspect 16, where the one or more transmission parameters include at least one of: a scheduling delay, a number of backscattering resource occasions, a backscattering interval, a modulation format, a coding scheme, a coding rate, a transmission duration, or a frequency for switching antenna reflection coefficient.

Aspect 18 is the method of any of aspects 12 to 14, where receiving the backscatter signal includes: receiving the backscatter signal on a number of semi-persistent backscatter link resources and with a resource periodicity that is within a period of the reference signal.

Aspect 19 is the method of any of aspects 12 to 18, further comprising: providing a continuous wave signal or an unmodulated carrier wave signal after the reference signal, where the backscatter signal is based on the continuous wave signal or the unmodulated carrier wave signal.

Aspect 20 is the method of any of aspects 12 to 19, further comprising: providing an energy packet after the reference signal or between backscattering information signals to provide power to be harvested by the passive backscatter device.

Aspect 21 is the method of any of aspects 12 to 20, further comprising: providing a power threshold, where the backscatter link resource in which the backscatter signal is received is based on a measurement of the reference signal meeting the power threshold.

Aspect 22 is the method of any of aspects 12 to 21, further comprising: receiving an indication of early termination for the backscatter signal, the early termination being based on available energy at the passive backscatter device; and stopping reception of the backscatter signal before a configured transmission number.

Aspect 23 is the method of any of aspects 12 to 22, further comprising: transmitting. via at least one transceiver of the reader, a number of consecutive reference signal transmissions to the passive backscatter device; and identifying the passive backscatter device as being out of coverage on a condition of no response being received to the number of consecutive reference signal transmissions.

Aspect 24 is the method of aspect 23, further comprising: releasing the backscatter link resources of the configuration based on the passive backscatter device being out of the coverage.

Aspect 25 is an apparatus for wireless communication including means for implementing any of aspects 1 to 11.

Aspect 26 is a computer-readable medium (e.g., a non-transitory computer-readable medium) storing computer executable code, the code when executed by at least one processor causes the at least one processor to implement any of aspects 1 to 11.

Aspect 27 is an apparatus for wireless communication at a network node. The apparatus includes a memory; and at least one processor coupled to the memory and, based at least in part on information stored in the memory, the at least one processor is configured to implement any of aspects 12 to 24.

Aspect 28 is the apparatus of aspect 27, further including at least one of a transceiver or an antenna coupled to the at least one processor.

Aspect 29 is an apparatus for wireless communication including means for implementing any of aspects 12 to 24.

Aspect 30 is a computer-readable medium (e.g., a non-transitory computer-readable medium) storing computer executable code, the code when executed by at least one processor causes the at least one processor to implement any of aspects 12 to 24.

1. An apparatus for wireless communication at a passive backscatter device, comprising:
a memory; and
at least one processor coupled to the memory and, based at least in part on information stored in the memory, the at least one processor is configured to:
receive a configuration for backscatter link resources and resources for at least one reference signal associated with the backscatter link resources;
receive a reference signal from the at least one reference signal associated with the backscatter link resources; and
backscatter an information signal in a backscatter link resource from the configuration in response to receiving the reference signal.

2. The apparatus of claim 1, wherein the reference signal comprises a group common reference signal having multiple associated backscatter link resources, wherein at least one processor is further configured to:
select the backscatter link resource from the multiple associated backscatter link resources.

3. The apparatus of claim 1, wherein the configuration includes multiple reference signals that are dedicated for the passive backscatter device, wherein to backscatter the information signal, the at least one processor is configured to:
backscatter the information signal to a reader using one or more transmission parameters based on the reference signal from the multiple reference signals.

4. The apparatus of claim 3, wherein the one or more transmission parameters include at least one of:
a scheduling delay,
a number of backscattering resource occasions,
a backscattering interval,
a modulation format,
a coding scheme,
a coding rate,
a transmission duration, or
a frequency for switching antenna reflection coefficient.

5. The apparatus of claim 1, wherein to backscatter the information signal, the at least one processor is configured to:
backscatter the information signal on a number of semi-persistent backscatter link resources and with a resource periodicity that is dependent on the reference signal.

6. The apparatus of claim 1, wherein the configuration includes multiple references signals, each reference signal associated with one of multiple readers, and wherein to backscatter the information signal, the at least one processor is configured to:
backscatter the information signal to a reader associated with the reference signal received by the passive backscatter device.

7. The apparatus of claim 1, wherein the at least one processor is further configured to:
receive a continuous wave signal or an unmodulated carrier wave signal after the reference signal, wherein the information signal is backscattered based on the continuous wave signal or the unmodulated carrier wave signal.

8. The apparatus of claim 1, wherein the at least one processor is further configured to:
harvest power from an energy packet after the reference signal or between backscattering information signals.

9. The apparatus of claim 1, wherein the at least one processor is further configured to:
transmit an indication of early termination for the information signal, the early termination being based on an available energy at the passive backscatter device; and
stop backscatter of the information signal before a configured transmission number.

10. The apparatus of claim 1, wherein to backscatter the information signal, the at least one processor is configured to:
backscatter the information signal a number of times based on a signal strength of the reference signal.

11. (canceled)

12. An apparatus for wireless communication at a reader, comprising:
a memory; and
at least one processor coupled to the memory and, based at least in part on information stored in the memory, the at least one processor is configured to:
transmit a reference signal associated with a configuration of backscatter link resources;
transmit a carrier signal to a passive backscatter device; and
receive a backscatter signal in an backscatter link resource from the configuration in response to the reference signal and based on the carrier signal.

13. The apparatus of claim 12, wherein the at least one processor is further configured to:
select the reference signal based on a transmission strategy to provide an energy packet to power the passive backscatter device.

14. The apparatus of claim 12, wherein the at least one processor is further configured to:
provide the configuration for the backscatter link resources and resources for at least one reference signal associated with the backscatter link resources.

15. The apparatus of claim 12, wherein the reference signal comprises a group common reference signal having multiple associated backscatter link resources, wherein the backscatter signal is received in the backscatter link resource from the multiple associated backscatter link resources.

16. The apparatus of claim 12, wherein the configuration includes multiple reference signals that are dedicated for the passive backscatter device, wherein to receive the backscatter signal, the at least one processor is configured to:
receive the backscatter signal having one or more transmission parameters based on the reference signal from the multiple reference signals.

17. The apparatus of claim 16, wherein the one or more transmission parameters include at least one of:
a scheduling delay,
a number of backscattering resource occasions,
a backscattering interval,
a modulation format,
a coding scheme,
a coding rate,
a transmission duration, or
a frequency for switching antenna reflection coefficient.

18. The apparatus of claim 12, wherein to receive the backscatter signal, the at least one processor is configured to:
receive the backscatter signal on a number of semi-persistent backscatter link resources and with a resource periodicity that is dependent on the reference signal.

19. The apparatus of claim 12, wherein the carrier signal is a continuous wave signal or an unmodulated carrier wave signal transmitted after the reference signal, wherein the backscatter signal is based on the continuous wave signal or the unmodulated carrier wave signal.

20. The apparatus of claim 12, wherein the at least one processor is further configured to:
provide an energy packet after the reference signal or between backscatter signals to provide power to be harvested by the passive backscatter device.

21-24. (canceled)

25. A method of wireless communication at a passive backscatter device, comprising:
receiving a configuration for backscatter link resources and periodic resources for at least one reference signal associated with the backscatter link resources;
receiving a reference signal from the at least one reference signal associated with the backscatter link resources; and
backscattering an information signal in a backscatter link resource from the configuration in response to receiving the reference signal.

26-30. (canceled)
